(19) United States
(12) Patent Application Publication
(10) Pub. No.: US 2006/0033717 A1
(43) Pub. Date: Feb. 16, 2006

(54) Optical sensor device

(76) Inventor: Lewis S. Beach, Bel Air, MD (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/862,575

(22) Filed: Jun. 8, 2004

(51) Int. Cl. G09G 5/08

(52) U.S. Cl. 345/167

(57) ABSTRACT

An optical sensor, includes a trackball, a cradle supporting the trackball, the cradle allowing linear movement in multiple perpendicular axes relative to the trackballs, a first sensor for detecting pitch, roll and yaw of the trackball and creating an output corresponding to the detected pitch, roll and yaw, a second sensor for detecting linear movement of the cradle and creating an output corresponding to the detected linear movement, and a processor, responsive to the output of pitch, roll and yaw and the output of linear movement, for generating an intuitive control output of pitch, roll, yaw and linear movement. The optical sensor allows for up to 6D output in an intuitive manner.

### BACKGROUND OF THE INVENTION

1. Field of the Invention

This invention relates to controlled devices having up to six degrees of freedom input to be operated by the human hand. More specifically, the present invention is an optical sensor device for intuitive interaction in up to six degrees (6D) of movement. The optical sensor of the present invention looks, feels and acts like a standard trackball, but when the user wants to interact in higher dimensions, it can provide up to six degrees of intuitive manipulation.

2. Description of the Related Art

A six degrees of freedom graphics controller is disclosed in U.S. Pat. No. 5,565,891 issued to B. Armstrong. This controller includes a trackball retained by a carriage. The trackball is rotatable independent of the carriage. Sensors are provided for detecting linear movement of the carriage and rotational movement of the trackball. Although the device is capable of six degrees of freedom, it has apparent disadvantages. The linear movement of the platform is restricted to be along mutually perpendicular X, Y, & Z axes which does not lend itself to wrist-only movement. Larger linear movements can require the user to move their forearm or their whole arm. The trackball itself is less than 50% accessible to the user's fingertips. Some 6D manipulations cannot be done using only one finger and thumb of one hand with this device because the user cannot grasp the trackball with finger and thumb while simultaneously rotating the trackball and moving the platform. This device requires more fingers, in complicated dexterity, or another hand for some 6D manipulations.

A 3D trackball was introduced by Myung-Soo Kim, Joon-Kyung Seong, Dae-Eun Hyun, Kang-Hoon Lee, and Yoo-Jin Choi at the Ninth Pacific Conference on Computer Graphics and Applications (PG'01) Oct. 16-18, 2001 in Tokyo, Japan. Their design provides for 3 degrees of motion for rotation using one 3D trackball, and 3 degrees of motion for translation using another 3D trackball. This implementation requires two hands for 6 degree movement. Using a trackball for translational movement is counterintuitive and would require training to master. Their design excludes the use of a single sensor for detecting 3D rotation. When using 2 sensors their design has each sensor contribute to the x, y, and z rotation. Their presentation states that 3 sensors are optimal to provide numerical stability.

Accordingly, there is a need for further improvements in the field of controllers for manipulating graphics such as on or through a computer and monitor or television screen or any display.

### SUMMARY OF THE INVENTION

Modern virual reality, computer assistant surgery, computer aided design, and other human/computer interaction explicitly extend beyond 2 dimensions (i.e., beyond a flat page or screen). The present invention provides for development of an inexpensive device for intuitive interaction in 6D.

Although there are many hand-manipulated trackballs for use as computer control devices, none are structured similarly to the present invention, and none offer all of the advantages provided by the present invention due to the significant structural differences.

The present invention enhances a standard trackball mouse, that produces a 2D output, so as to allow 2D, 3D and up to 6D output in an intuitive manner. The 6D trackball of the present invention looks and behaves the same as a standard 2D trackball. The 6D trackball works exactly the same as a 2D trackball when used with standard 2D applications. This benefit eliminates the need for traing, eliminates any breaking-in period, and avoids having to attach extra devices to the system.

When the user wants to rotate something in 3D, the user simply rotates the 6D trackball in the manner that the user wants the 3D object to be rotated. Every rotation of the 6D trackball (i.e., roll, pitch, and yaw) will be mirrored by the 3D object. This provides immediate intuitive manipulation.

When the user wants to move something in 3D, the user simply grasps the 6D trackball and pushes or pulls it (not rotate) in the direction the user wants the 3D object to move. A gentle push can move the object slowly, whereas a firmer push moves the object faster. In some applications, this movement could be interpreted as acceleration, rocket thrusts, airplane controls, etc. Every movement of the 6D trackball (left/right, front/back, and up/down) will be mirrored by the 3D object.

When the user wants to manipulate something in 6D, the user rotates the 6D trackball and simultaneously pushes or pulls the 6D trackball to allow immediately intuitive 6D manipulation.

These and other advantages of the present invention can be achieved by an optical sensor, which includes:

a trackball;

a cradle supporting the trackball, the cradle allowing nearly linear movement in multiple perpendicular axes relative to the trackball, the cradle tilts left/right & front/back like a joystick plus allows up/down movement to allow Z-axis movement;

a first sensor for detecting pitch, roll and yaw of the trackball and creating an output corresponding to the detected pitch, roll and yaw;

a second sensor for detecting linear movement of the cradle and creating an output corresponding to the detected linear movement; and

a processor responsive to the output of pitch, roll and yaw and the output of X, Y, & Z linear movement for generating and intuitive control output of pitch, roll, yaw and X, Y, & Z linear movement.

These and other advantages of the present invention will become better understood upon consideration of the following description and drawings.

### BRIEF DESCRIPTION OF THE DRAWINGS

FIG. 1 is a perspective view of the optical sensor in accordance with the present invention.

FIG. 2 is a schematic of the optical sensor in accordance with the present invention.

FIG. 3 is a schematic view of an embodiment of the movable cradle of the invention.

FIG. 4 is a schematic of a variation of the optical sensor in accordance with the present invention.

### BEST MODE FOR CARRYING OUT THE INVENTION

Referring to the drawings, a preferred embodiment of the optical sensor according to the present invention is described.

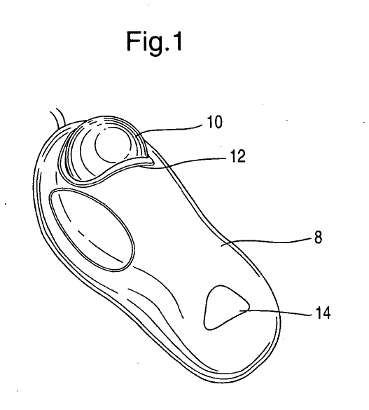

FIG. 1 is a perspective view of the optical sensor in accordance with the present invention. The optical sensor is provided with a housing 8 and trackball 10 which is supported by a movable cradle 12. Cradle 12 is supported within the housing 8 so as to allow the cradle 10 to be movable or moved in all linear directions relative to the housing 8, for example, left, right, forward, rearward, up and down, and in all possible combinations thereof. The extra left mouse button, 14, is required when the thumb is involved in manipulation of the trackball. A user may comfortably grasp and manipulate the trackball with the thumb and middle finger—this leaves the index finger free to press the left mouse button. In such case the position of the extra left mouse button could be in front of the tackball.

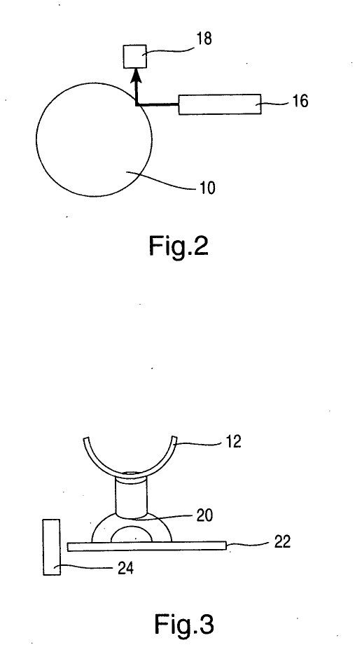

FIG. 2 is a schematic of the optical sensor in accordance with the present invention. A light source 16 emits a beam of light onto the trackball 10 such that the beam is reflected onto a 3D sensor 18. The 3D sensor detects perpendicular, X & Y, linear movement of the trackball 10, as well as rotational, angular, movement of the trackball. The 3D sensor detects pitch, roll and yaw of the trackball 10. In this preferred embodiment, the trackball is provided with a pattern so that the sensor can recognize changes in the position of the pattern relative to the sensor. Circuitry associated with the sensor determines movement of the pattern across the array, and translates that movement into conventional cursor control signals supplied to a host system.

FIG. 3 is a schematic view of an embodiment of the movable cradle of the invention. The cradle 12 supports the trackball and allows the trackball full rotational movement. The cradle itself is supported on a standard 2D joystick 20 to allow X and Y linear movement. The joystick and associated circuitry is standard in the industry and relays the X and Y linear movement of the cradle to a host system. The 2D joystick 20 is mounted on a plastic semi-rigid flexible platform 22. This platform is rigid enough to keep the joystick stationary, yet flexible enough that moderate pressure exerted on the trackball will allow the trackball/cradle assembly to move up and down. The platform keeps the joystick at a fixed horizontal position. When pressure is exerted on the trackball 10 or cradle 12 by the user the platform 22 allows horizontal movement (up and down). This 3^{rd} degree of freedom is detected by a sensor 24 located adjacent to the platform 22. The movement is translated into Z-axis movement by associated circuitry. The resulting X, Y, and Z (3D) signals are supplied to the host system via the associated circuitry.

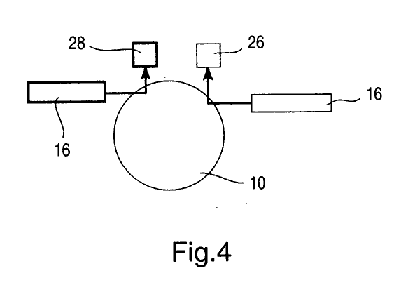

FIG. 4 is a schematic of a variation of the optical sensor in accordance with the present invention. This variation incorporates one 2D sensor 26 and one 1D sensor 28 positioned perpendicular to each other 90 degrees apart relative to the surface of the trackball 10. The 2D sensor 26 is a well-known device, and is described, for example, in U.S. Pat. No. 5,703,356 to Bidiville et al. incorporated herein in its entirety. Such “marble” technology reflects light onto the surface of a trackball that has a pattern painted on its surface. The sensor picks up the reflection of the light and detects changes in the reflection. Those changes are sent to the computer as changes in 2D. In FIG. 4 the present invention upgrades this basic technology by adding a second sensor 28. The second sensor 28 is located perpendicular to the first sensor 26. The 1D sensor can be realized by using a second 2D sensor and simply ignoring one of the 2D signals. The X, Y movement detected by the 2D sensor is translated into roll and pitch rotational movement by associated circuitry. The X movement detected by the 1D sensor is translated into yaw rotational movement by associated circuitry. The resulting roll, pitch, and yaw rotational (3D) signals are supplied to the host system via the associated circuitry.

As described, the trackball and corresponding sensor(s) are provided for detecting pitch, roll and yaw to create an output corresponding to the detected pitch, roll and yaw. Furthermore, the cradle and sensor for detecting linear movement of the cradle are provided to create an output corresponding to the detected linear movement. These outputs are sent to a processor (i.e., computer), so as to process these outputs in order to generate an intuitive control output of the pitch, roll, yaw and linear movement.

All signals from the optoelectronic devices are fed to a small, inexpensive, single-chip microcomputer (MPU) that is available on the market as a standard product. The output from the MPU is sent to a standard mouse or joystick input on a users computer.

Although the best mode of the invention has been described, it should be apparent that many changes could be made to the specific structures and mode without departing from the spirit and scope of the invention.

What I claim as my invention is:

1. An optical sensor, comprising:
a trackball;
a cradle supporting said trackball, said cradle allowing linear movement in multiple perpendicular axes relative to said trackball;
a first sensor for detecting pitch, roll and yaw of said trackball and creating an output corresponding to said detected pitch, roll and yaw;
a second sensor for detecting linear movement of said cradle and creating an output corresponding to said detected linear movement; and
a processor , responsive to said output of pitch, roll and yaw and said output of linear movement, for generating an intuitive control output of pitch, roll, yaw and linear movement.

2. The optical sensor according to claim 1, wherein said first optical sensor comprises two sensors spaced apart from each other.

3. The optical sensor according to claim 1, further comprising a light source for illuminating said trackball, wherein said trackball is provided with a pattern.

4. The optical sensor according to claim 1, further comprising a joystick supporting said cradle.
